(19) United States
(12) Patent Application Publication
(10) Pub. No.: US 2008/0160354 A1
(43) Pub. Date: Jul. 3, 2008

(54) Metal alloy bipolar plates for fuel cell

(76) Inventors: Weilong Zhang, Glastonbury, CT (US); Patrick L. Hagans, Columbia, CT (US); Nikunj Gupta, Windsor, CT (US); John A. Needham, Southington, CT (US); John G. Smeggil, Simsbury, CT (US)

Correspondence Address: CARLSON, GASKEY & OLDS, P.C., 400 WEST MAPLE ROAD, SUITE 350, BIRMINGHAM, MI, 48009, US

(21) Appl. No.: 11/646,203

(22) Filed: Dec. 27, 2006

(51) Int. Cl. H01M 8/04; H01M 2/14

(52) U.S. Cl. 429/13; 429/34

(57) ABSTRACT

An article for use in a fuel cell stack (10) includes a bipolar plate (30) that includes a metal alloy having a nominal composition of about 40 wt % to 60 wt % nickel, about 12 wt % to 25 wt % chromium, about 10 wt % to 35 wt % iron, and about 5 wt % to 10 wt % of at least one element from aluminum, manganese, molybdenum, niobium, cobalt, vanadium, and combinations thereof.

### 1. FIELD OF THE DISCLOSURE

This disclosure generally relates to fuel cells and, more particularly, to flow field plates for fuel cells.

### 2. DESCRIPTION OF THE RELATED ART

Fuel cells are widely known and used for generating electricity in a variety of applications. Typically, a fuel cell unit includes an anode, a cathode, and an ion-conducting polymer exchange membrane (PEM) between the anode and the cathode for generating electricity in a known electrochemical reaction. Several fuel cell units are typically stacked together to provide a desired amount of electrical output. Typically, a bipolar plate is used to separate adjacent fuel cell units. In many fuel cell stack designs, the bipolar plate also functions to conduct electrons within an internal circuit as part of the electrochemical reaction to generate the electricity.

Presently, the bipolar plates are made of graphite to provide electrical conductivity. The graphite is also resistant to corrosion within the relatively harsh environment of the fuel cell. However, a significant drawback of using graphite is that the plate must be relatively thick to achieve a desired strength, thereby reducing power density of the fuel cell stack. Alternatively, there have been proposals to fabricate the bipolar plates out of a metal. However conventional metal stainless steels selected as a first choice for the fuel cell environment form a protective oxide layer that is electrically insulating and thus undesirably increases an electrical contact resistance between the bipolar plate and the adjacent cathode and anode electrodes. These type of separator plates are therefore unacceptable although they do meet to general cost goals for such a plate. Alternatively, some specialty alloys such as Haynes 230 offer reduced electrical contact resistance compared to conventional stainless steel but are prohibitively expensive and therefore also unacceptable. Therefore what is needed is a metal bipolar separator plate material that resists corrosion, has low electrical contact resistance and is cost competitive with conventional stainless steels. Such a material will allow fuel cells to use a relatively thin bipolar plate which results in increased fuel cell stack power density and reduced cost.

### SUMMARY OF THE DISCLOSURE

One example article for use in a fuel cell stack includes a bipolar metal plate that includes a metal alloy having a nominal composition of about 40 wt % to 60 wt % nickel, about 12 wt % to 25 wt % chromium, about 10 wt % to 35 wt % iron, and about 5 wt % to 10 wt % of at least one element from aluminum, manganese, molybdenum, niobium, cobalt, and vanadium.

A method of controlling the operational electrical contact resistance of a metal bipolar plate for use in a fuel cell stack includes the step of employing an amount of a mixture of chromium, iron, and nickel oxide that satisfies the need for corrosion resistance and electrical contact resistance

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates selected portions of an example fuel cell stack.

FIG. 2 illustrates an example bipolar plate for use in the example fuel cell stack.

FIG. 3 illustrates another example bipolar plate for use in the example fuel cell stack.

### DETAILED DESCRIPTION OF THE PREFERRED EMBODIMENTS

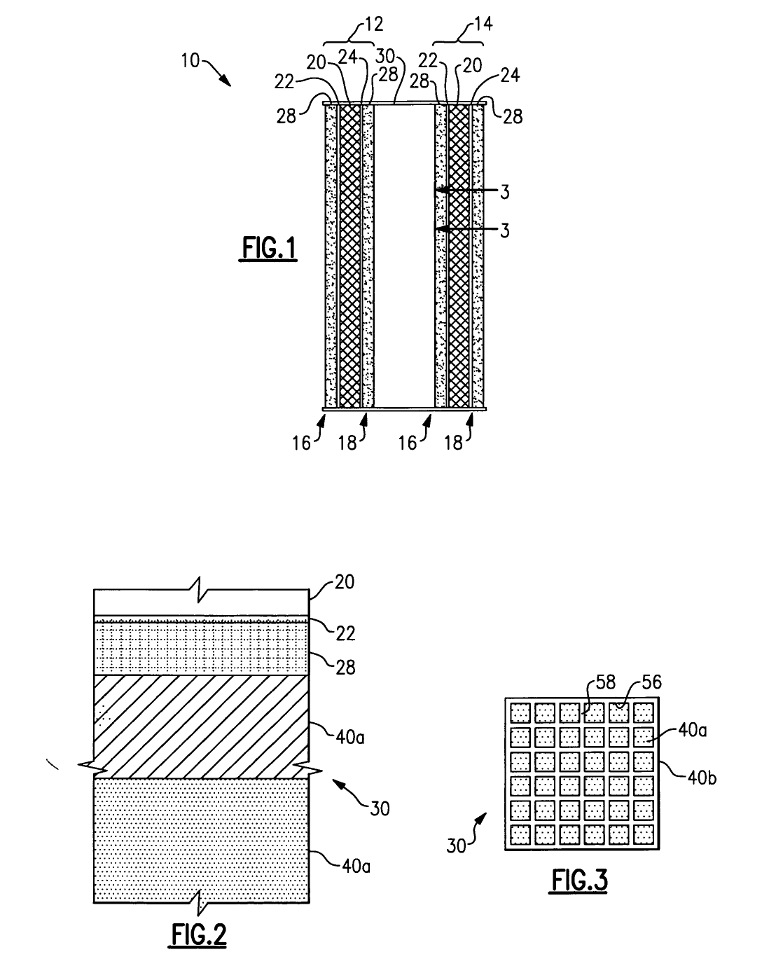

FIG. 1 schematically illustrates selected portions of an example fuel cell stack 10 for generating electricity. In this example, the fuel cell stack 10 includes fuel cells 12 and 14 that each includes a cathode 16 (electrode) that receives a first reactant gas and an anode 18 (electrode) that receives a second reactant gas to generate an electric current using a known reaction. Each fuel cell 12 and 14 includes a polymer exchange membrane (PEM) 20 that separates a cathode catalyst 22 from an anode catalyst 24, and gas diffusion layers 28 that distribute the reactant gases over the respective cathode catalyst 22 and anode catalyst 24 in a known manner. In one example, the gas diffusion layers 28 include a porous material such as a porous carbon cloth. A metal bipolar plate 30 separates the fuel cells 12 and 14.

In the illustrated example, the metal bipolar plate 30 is a single, continuous layer. Alternatively, as illustrated in FIG. 2, the metal bipolar plate 30 includes a first metal layer 40a coupled with at least one second metal layer 40b.

FIG. 3 illustrates a selected portion of another embodiment of the metal bipolar plate 30, in which the second metal layer 40b is a mesh that is coupled with the first metal layer 40a. In this example, the second metal layer 40b includes wires 54 arranged with openings 56 in between the wires 54. Given this description, one of ordinary skill in the art will recognize alternative types of mesh patterns suitable to meet their particular needs.

In operation, the electrochemical reactions of the reactant gases within the fuel cells 12 and 14 produce a relatively harsh environment for the metal bipolar plate 30. For example, the cathode 16 produces an acidic oxidizing environment and the anode 18 produces an acidic, reducing environment. In the harsh cathode environment the surfaces of the metal bipolar plate 30 grow an oxide layer. The oxide layer may contain mixed oxides of nickel, chromium, iron, plus minor amounts of other elements contained within the metal bipolar plate 30.

Chromium and iron oxide layers or mixtures thereof are generally poor electrical conductors and therefore tend to increase contact surface resistance between the bipolar plate 30 and the fuel cells 12, 14 (i.e., a measure of the conductivity between the metal bipolar plate 30 and either of the fuel cell gas diffusion layers 28). The addition of nickel oxide to the mixture of chromium and iron oxide results in an acceptable electrical contact surface resistance for the metal bipolar plate. A relatively thin chromium, iron, and nickel oxide layer corresponds to a relatively low electrical contact surface resistance, and a relatively thick chromium, iron, and nickel oxide layer corresponds to a relatively high electrical contact surface resistance. Thus, the thickness of the chromium, iron, and nickel oxide layer corresponds to the ability of the metal bipolar plate 30 to conduct electrical current within an internal circuit as part of the electrochemical reaction to generate electricity.

Additionally, the composition of the oxide layer influences the electrical surface contact resistance and the corrosion resistance. For example, chromium oxides increase corrosion resistance while iron oxide and nickel oxide are relatively poor for corrosion resistance. Conversely, nickel oxide or hydroxide desirably reduces surface contact resistance, whereas chromium oxide and iron oxide have relatively high surface contact resistance.

The thickness and composition of the oxide layer thereby represents a balance between the competing interests of low electrical surface contact resistance and relatively high corrosion resistance. A desired balance (and thus the thickness and composition) may be varied depending on the desired operating parameters for a given fuel cell stack design.

In the disclosed examples, the metal bipolar plate 30 includes a metal alloy having a nominal composition that provides the benefit of a desirable balance between electrical surface contact resistance and corrosion resistance, as will be described below. For example, the single, continuous layer of the metal bipolar plate 30 includes the metal alloy. In another example, the second metal layer 40b (FIGS. 2 and 3) includes the metal alloy, and the first metal layer 40a includes a metal alloy having a different chemical composition than the metal alloy of the second metal layer 40b.

The nominal composition of the metal alloy includes about 40 wt % to 60 wt % nickel, about 12 wt % to 25 wt % chromium, about 10 wt % to 35 wt % iron, and about 5 wt % to 10 wt % of at least one element from aluminum, manganese, molybdenum, niobium, cobalt, vanadium, and combinations thereof. In a further example, the nominal composition includes at least two of the elements from aluminum, manganese, molybdenum, niobium, cobalt, and vanadium. However a more particular composition of a bipolar metal plate includes a metal alloy having a preferred composition of about 45 wt % to 55 wt % nickel, about 12 wt % to 20 wt % chromium, about 10 wt % to 25 wt % iron, and about 5 wt % to 10 wt % of at least one element from aluminum, manganese, molybdenum, niobium, cobalt, and vanadium and a most particular composition of a bipolar metal plate includes a metal alloy having a most preferred composition of about 45 wt % to 50 wt % nickel, about 15 wt % to 20 wt % chromium, about 15 wt % to 25 wt % iron, and about 5 wt % to 10 wt % of at least one element from aluminum, manganese, molybdenum, niobium, cobalt, and vanadium. The term “about” as used in this description relative to the compositions refers to possible variation in the compositional percentages, such as normally accepted variations or tolerances in the art.

The nominal composition provides a desirable level of electrical surface contact resistance and a desirable level of corrosion resistance (e.g., as measured by corrosion rate in a simulated fuel cell environment). Within the nominal composition described above, the nickel forms oxides having a relatively low electrical surface contact resistance, while the chromium oxide provides a relatively high corrosion resistance. However, chromium and nickel are relatively expensive and, depending on the design of a particular fuel cell stack, provide a level of surface contact resistance and corrosion resistance that exceeds what is needed for normal fuel cell stack 10 operation.

The elements aluminum, niobium, cobalt, manganese, vanadium, or combinations thereof are employed within the nominal composition to improve the physical properties of the metal alloy and are of secondary importance to the practice of the disclosure.

The successful application of the oxides to the bipolar plate indicates that using less iron in combination with more chromium and nickel within the ranges described above for nominal composition of the metal alloy results in an oxide layer having mixed oxides that overall have a relatively low contact resistance and a relatively high corrosion resistance because of the relatively greater amounts of nickel and chromium, while using more iron in combination with less chromium and nickel achieves an oxide layer having mixed oxides that overall have a relatively higher contact resistance and a relatively lower corrosion resistance because of the relatively greater amount of iron. Increasing the iron content has the advantage of reducing plate cost, so its content will be increased as much as possible while maintaining acceptable corrosion protection and acceptable electrical contact. The electrical contact should be on the order of about 4 to 6 mOhms (milliohms).

The disclosed example metal bipolar plate 30 provides the benefit of improved power density compared to previously known graphite or metal bipolar plates. The example metal bipolar plates 30 provide a desired level of electrical surface contact resistance and corrosion resistance. Moreover, the high strength of metallic materials compared to graphite allows the example bipolar plates 30 to be relatively thinner compared to graphite plates. Thinner bipolar plates reduce the cell stack assembly volume and provide more power per volume of a fuel cell stack.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. An article for use in a fuel cell stack, comprising:
a bipolar plate including a metal alloy having a nominal composition that includes about 40 wt % to 60 wt % nickel, about 12 wt % to 25 wt % chromium, about 10 wt % to 35 wt % iron, and about 5 wt % to 10 wt % of at least one element selected from the group consisting of aluminum, manganese, molybdenum, niobium, cobalt, and vanadium.

2. The article as recited in claim 1, wherein the bipolar plate comprises a non-continuous mesh.

3. The article as recited in claim 1, wherein the bipolar plate comprises a continuous, planar sheet.

4. The article as recited in claim 1, wherein the bipolar plate comprises a first layer including a first metal alloy that is different than the metal alloy and a second layer bonded to the first layer, the second layer comprising the metal alloy.

5. The article as recited in claim 1, wherein the metal alloy includes at least two of the elements.

6. The article as recited in claim 1, wherein the nominal composition includes about 45 wt % to 55 wt % of the nickel, about 12 wt % to 20 wt % of the chromium, and about 10 wt % to 25 wt % of the iron.

7. The article as recited in claim 1, wherein the nominal composition includes about 45 wt % to 50 wt % of the nickel, about 15 wt % to 20 wt % of the chromium, and about 15 wt % to 25 wt % of the iron.

8. A fuel cell assembly comprising:
a plurality of electrodes; and
a bipolar plate associated with the electrodes, the bipolar plate including a metal alloy having a nominal composition that includes about 40 wt % to 60 wt % nickel, about 12 wt % to 25 wt % chromium, about 10 wt % to 35 wt % iron, and about 5 wt % to 10 wt % of at least one element from aluminum, manganese, molybdenum, niobium, cobalt, vanadium, and combinations thereof.

9. A method of controlling operation of a fuel cell stack containing a bipolar plate wherein the bipolar plate has an electrical contact resistance in the range of 4 to 6 milliohms.

10. A method of controlling operation of a fuel cell stack containing a bipolar plate wherein the bipolar plate includes a metal alloy having a nominal composition, the method comprising:
employing an amount of 40 wt % to 60 wt % nickel, within the nominal composition to establish a desired level of electrical contact resistance between the bipolar plate and an electrode within the fuel cell stack.

11. The method as recited in claim 9, including employing about 12 wt % to 25 wt % chromium, in the nominal composition to establish the desired level of corrosion protection.

12. The method as recited in claim 10, including employing about 10 wt % to 35 wt % iron, in the nominal composition to reduce the levels of nickel and chrome without reducing the desired level of corrosion protection and a desired level of electrical contact resistance.
